(19) United States
(12) Patent Application Publication
(10) Pub. No.: US 2014/0110558 A1
(43) Pub. Date: Apr. 24, 2014

(54) PARALLEL ENGINE MOUNT STRUCTURE

(71) Applicant: HYUNDAI MOTOR COMPANY, Seoul (KR)

(72) Inventor: Seung Won Kim, Seoul (KR)

(73) Assignee: HYUNDAI MOTOR COMPANY, Seoul (KR)

(21) Appl. No.: 13/859,162

(22) Filed: Apr. 9, 2013

(30) Foreign Application Priority Data
Oct. 24, 2012 (KR) 10-2012-0118358

(51) Int. Cl. F16M 5/00

(52) U.S. Cl. CPC F16M 5/00
USPC 248/638

(57) ABSTRACT

A parallel engine mount structure that includes: a main rubber having a core at an upper portion thereof and a fluid chamber at a lower portion thereof and a housing shaped bracket disposed around the main rubber. A first membrane is mounted under the fluid chamber of the main rubber and is configured to reduce vibration. An orifice plate is disposed under the first membrane and a first cylinder is configured to operate with the orifice plate. A driver is disposed on one outer side of the bracket.

### CROSS-REFERENCE TO RELATED APPLICATION

This application is based on and claims priority from Korean Patent Application No. 10-2012-0118358, filed on Oct. 24, 2012 in the Korean Intellectual Property Office, the disclosure of which is incorporated herein in its entirety by reference.

### BACKGROUND OF THE INVENTION

1. Field of the Invention

The present invention relates to a parallel engine mount structure, and more particularly, to a parallel engine mount structure that minimizes the height of an engine mount by separating a driver mounted on the engine mount.

2. Description of the Prior Art

In general, vehicles are equipped with an engine mount for power train to prevent vibration generated from the power train from being transmitted to the vehicle bodies by effectively supporting the power train. The engine mount for a power train which supports an engine and a transmission is configured to reduce vibration and noise generated by the engine, in addition to supporting the power train.

FIGS. 1 and 2 are exemplary cross-sectional views showing an engine mount structure of the related art. An engine mount structure of the related art, as shown in FIG. 1, includes a main bridge 10 made of rubber, wherein a core 11 and a bolt 20 are inserted in the core 11 of the main bridge 10 and are connected with an engine. The engine mount structure of the related art is configured to resist the load of a power train and reduce vibration by absorbing vibration from the engine using a main bridge 10 with the bolt 20 inserted therein.

Further, in the engine mount structure of the related art, as shown in FIG. 2, a driver is disposed under the engine mount 1 such that a magnetic field and an absorption force are generated around a coil by a current due to a pressure change generated by vibration, and thus vibration of a vehicle is reduced by adjusting the internal pressure of the engine mount 1.

However, since the driver is disposed under the engine mount in the engine mount structure of the related art, the size of the engine mount increases and thus, the degree of freedom in the layout may be difficult to be secured and thus space is not efficiently used, causing a coupling feature of a frame to deteriorate.

### SUMMARY

Accordingly, the present invention provides a parallel engine mount structure which may minimize the height of an engine mount by separating a driver mounted on the engine mount.

In one aspect of the present invention, a parallel engine mount structure may include: a main rubber having a core at a upper portion thereof and a fluid chamber at a lower portion thereof; a housing shaped bracket disposed around the main rubber; a first membrane mounted under the fluid chamber of the main rubber and configured to reduce vibration; an orifice plate disposed under the first membrane; a first cylinder operating together with the orifice plate; and a driver disposed on one outer side of the bracket.

The driver may be an electromagnet. In addition, the driver may further include: a second cylinder connected with the first cylinder; and a second membrane disposed on the second cylinder. The second membrane may further include a vibrating plate formed vertically, and an armature corresponding to the vibrating plate may be disposed in the driver. The engine mount structure may further include a connection pipe that connects the first cylinder with the second cylinder.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are exemplary views showing an engine mount structure according to the related art;

FIG. 3 is an exemplary cross-sectional view showing a parallel engine mount structure according to an exemplary embodiment of the present invention;

FIGS. 4 and 5 are exemplary cross-sectional views showing turning on/off a driver of the parallel engine mount structure according to an exemplary embodiment of the present invention; and

FIG. 6 is an exemplary view showing a parallel engine mount structure according to an exemplary embodiment of the present invention.

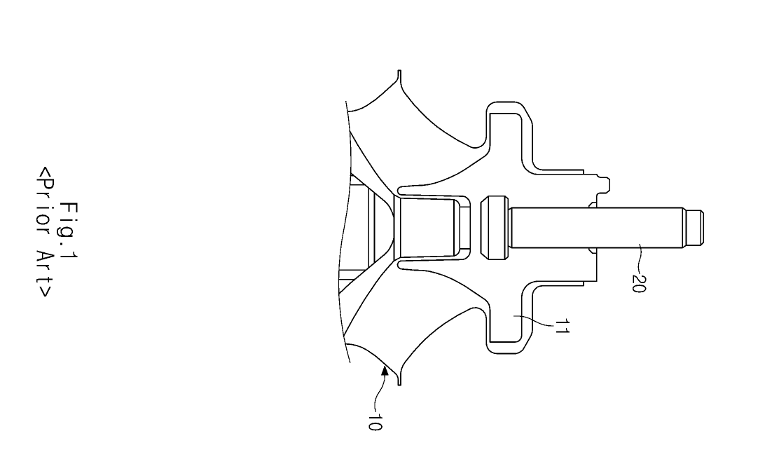

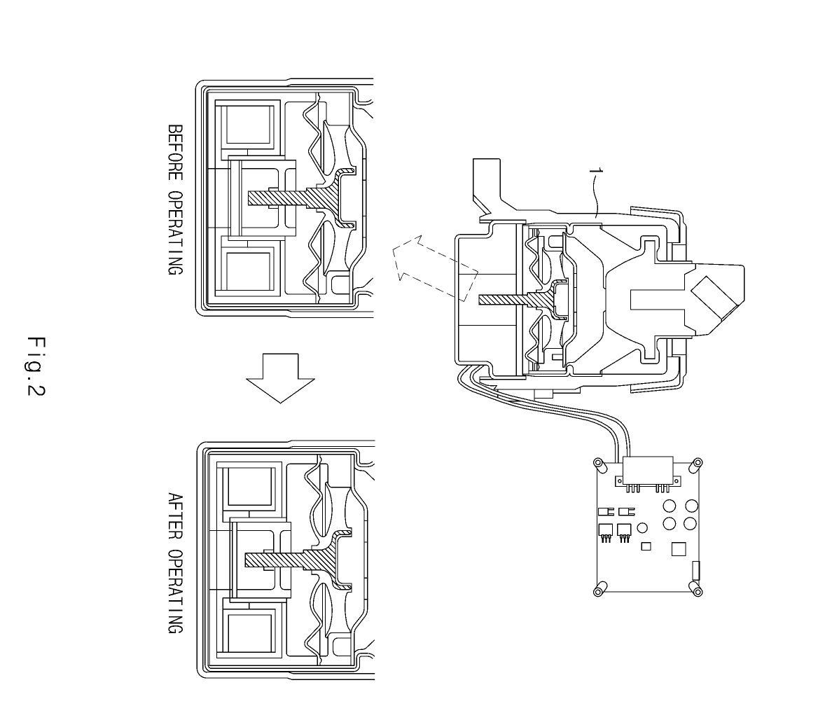

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Exemplary embodiments of the present invention will be described hereinafter in detail with reference to the accompanying drawings.

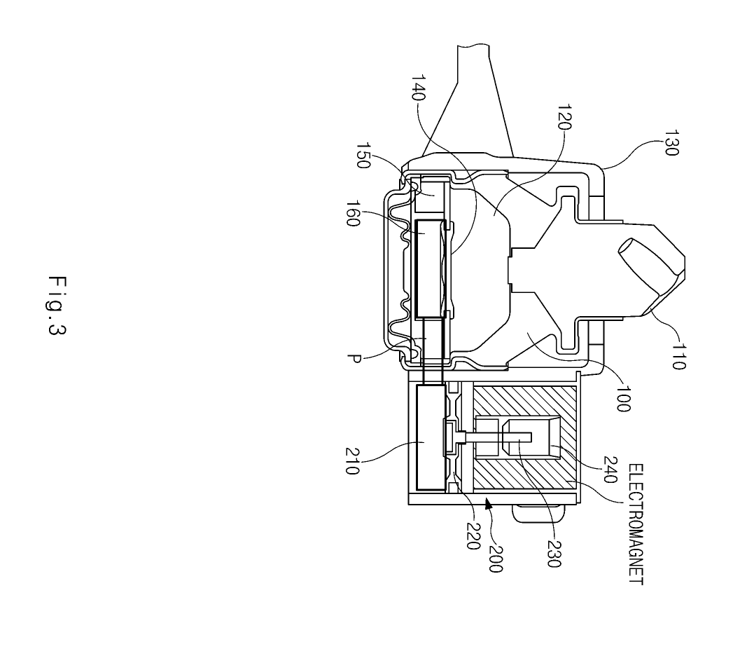

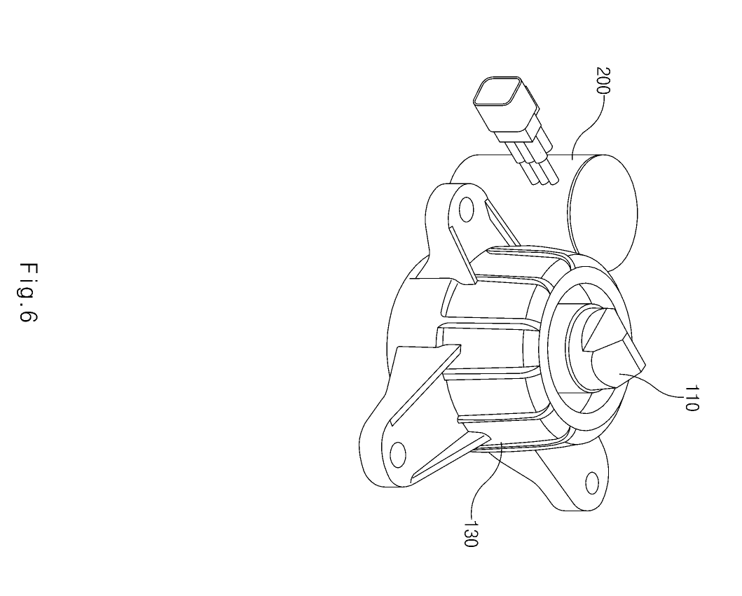

A parallel engine mount structure of the present invention, as shown in FIGS. 3 to 6, may include a main rubber 100 having a core 110 and a fluid chamber 120, a bracket 130 forming an outer side of the main rubber 100, a first membrane 140 and an orifice plate 150 disposed under the fluid chamber 120, a first cylinder 160 that operates together with the orifice plate 150, and a driver 200 disposed on the outer side of the bracket 130.

The main rubber 100 may be made of rubber and may be disposed on an exterior surface of the core 110. The fluid chamber 120 may be disposed under the main rubber 100, to allow fluid to flow within the engine mount. The bracket 130 may be disposed around the main rubber 100 and may be formed in the shape of a housing, to form the outer shape of the engine mount (e.g., the bracket 130 may be formed as an enclosure surrounding the main rubber 100). The first membrane 140, may be configured to reduce vibration of the engine mount and may be mounted under the fluid chamber 120 of the main rubber 100. The orifice plate 150 may be disposed under the first membrane 140 and may be configured to allow fluid to flow within the engine mount. The orifice plate 150 may be configured to operate together with the first cylinder 160 to allow the first cylinder 160 to move horizontally with flow of fluid, to allow a second cylinder 210 to be described below to be operated.

The driver 200, may be disposed at a first end of the outer side of the bracket 130 and may be configured to further reduce vibration. The driver 200 may include the second cylinder 210 that operates with the first cylinder 160 and a second membrane 220 disposed on the second cylinder 210, wherein the second cylinder 210 may be configured to be operated by the first cylinder 160 which may be operated by flow of fluid through the orifice plate 150 under the fluid chamber 120, and the second membrane 220 on the second cylinder 210 may be configured to further reduce vibration. Furthermore, the first cylinder 160 and the second cylinder 210 may be connected by a connection pipe P.

The driver 200 may be an electromagnet, and may include a vibrating plate 230 disposed above the second membrane 220, and an armature 240 disposed within the driver 200 to correspond to the vibrating plate 230, thus, when the driver 200 is an electromagnet the driver 200 may be configured to operate with generation of vibration, the armature 240 and the vibration plate 230 may correspond to each other and move the second membrane 220, thereby reducing vibration.

Since the parallel engine mount is formed by mounting the driver 200 on the outer side of the bracket 130 in the present invention, it may be possible to decrease the height of the engine mount and reduce vibration, using the first membrane 140 and the second membrane 220 disposed inside the bracket 130 and within the driver 200, respectively.

The orifice plate 150 may connect upper and lower liquid chambers disposed under the main rubber 100 inside the bracket 130 and the operational principle of the parallel engine mount structure of the present invention is described in relation to this configuration as follows.

When pressure is applied by the second membrane 220, fluid may be configured to flow toward the first membrane 140 by Pascal's principle (as known in the art) wherein when pressure is applied to fluid in a sealed container, the pressure is uniformly transmitted, and vibration of the engine mount may reduce.

Further, when no pressure is present, a substantially small amount of vibration transmitted to the first membrane 140 may be transmitted to the second membrane 220, thus, the armature 240 may attenuate the vibration, operating as a damper. Further, the first cylinder 160 inside the bracket 130 and the second cylinder 210 within the driver 200 may increase/decrease the magnitude of force, based on the size under Pascal's law.

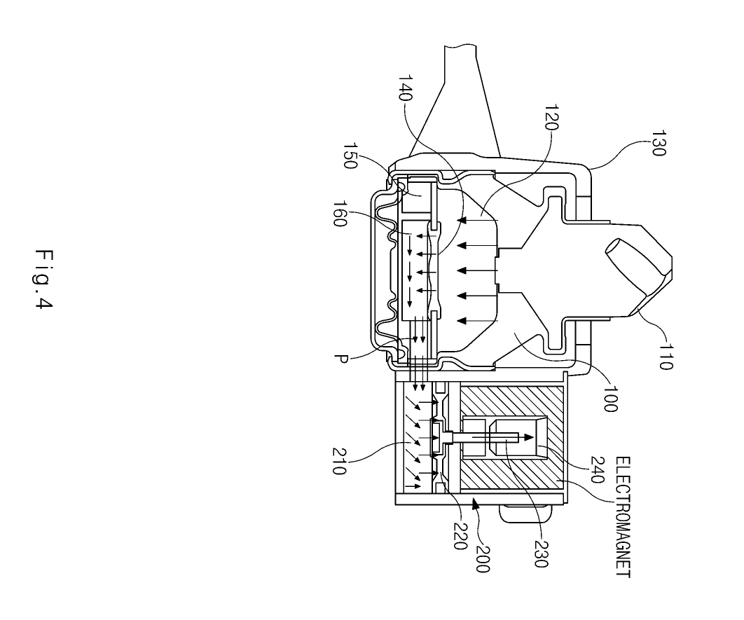

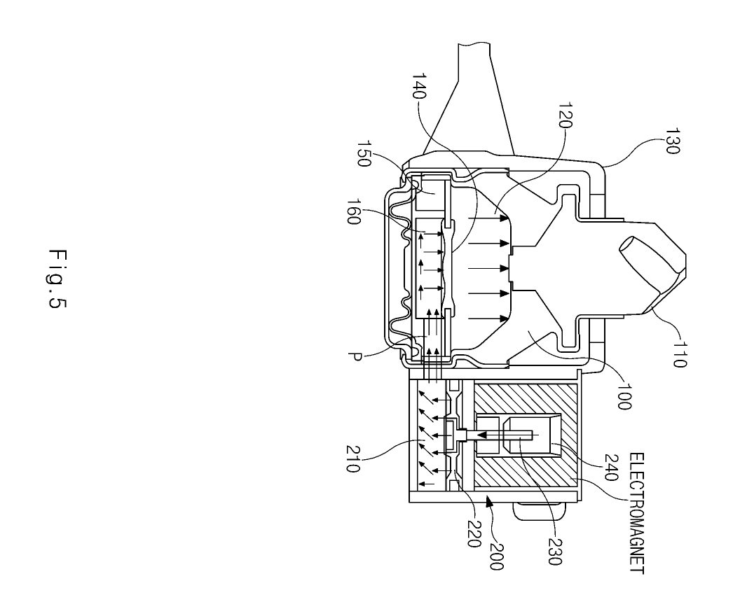

As described above, according to the present invention, the bracket 130 and the driver 200 may be horizontally arranged, to reduce the size of the engine mount. Further, as shown in FIG. 4, when the driver 200 is turned on, current may be configured to flow to the electromagnet, the armature 240 may be pulled, and the second membrane 220 may move vertically, to reduce vibration. In addition, when the driver 200 is turned off, as shown in FIG. 5, the current flowing to the electromagnet may be stopped, to allow the second membrane 220 to return to an original position.

According to the present invention, it may be possible to secure the degree of freedom in layout and improve space efficiency by decreasing the height of the engine mount, by separating the driver from the engine mount, to appropriately increase/decrease force transmitted between the engine mount and the driver by adjusting the size of the driver and the sizes of the first and second cylinders, and to improve a commercial value by attenuating vibration using the membranes, even when the driver is not used.

Although the present invention was described with reference to exemplary embodiments and drawings, the present invention is not limited thereto and may be changed and modified in various ways within the spirit of the present invention and claims described below by those skilled in the art.

What is claimed is:

1. A parallel engine mount structure, comprising:
a main rubber having a core at a upper portion of the main rubber and a fluid chamber at a lower portion of the main rubber;
a housing shaped bracket disposed around the main rubber;
a first membrane mounted under the fluid chamber of the main rubber and configured to reduce vibration;
an orifice plate disposed under the first membrane;
a first cylinder configured to operate with the orifice plate; and
a driver disposed on one outer side of the bracket.

2. The engine mount structure according to claim 1, wherein the driver is an electromagnet.

3. The engine mount structure according to claim 1, wherein the driver further includes:
a second cylinder connected with the first cylinder; and
a second membrane disposed on the second cylinder.

4. The engine mount structure according to claim 3, wherein the second membrane further includes:
a vibrating plate formed vertically; and
an armature corresponding to the vibrating plate and disposed within the driver.

5. The engine mount structure according to claim 3, further comprising:
a connection pipe that connects the first cylinder with the second cylinder.
